(19) United States
(12) Patent Application Publication
(10) Pub. No.: US 2026/0329248 A1
(43) Pub. Date: Oct. 22, 2026

(54) METHOD FOR MEASURING A CUTTING TOOL, AND COORDINATE MEASURING DEVICE FOR CARRYING OUT THE METHOD

(71) Applicant: Rollomatic S.A., Le Landeron (CH)

(72) Inventors: Christian KRUMM, Cortébert (CH); Mouhamad Ali FREIDY, Neuchâtel (CH)

(73) Assignee: Rollomatic S.A., Le Landeron (CH)

(21) Appl. No.: 19/109,701

(22) PCT Filed: Sep. 11, 2023
(86) PCT No.: PCT/EP2023/074934

§ 371 Date: Mar. 7, 2025

(30) Foreign Application Priority Data
Sep. 12, 2022 (EP) 22195239.3

(51) Int. Cl. G05B 19/401

(52) U.S. Cl. CPC G05B 19/401; G05B 2219/37227; G05B 2219/45159

(57) ABSTRACT

In a method and a coordinate measuring device for measuring a cutting tool, which includes a cutting tool body and at least one cutting insert with at least one cutting edge attached to the cutting tool body, the coordinate measuring device includes a fixing device which receives and fixes the cutting tool, a measuring head which probes the surface of the cutting tool arranged in the fixing device with contact or without contact, whereby the measuring head is movable relative to the fixing device and a movement device which moves the cutting tool received in the fixing device and the measuring head relative to each other. The measuring head is moved along a movement path relative to the cutting tool in order to determine the coordinates of cutting edge boundary surfaces at predetermined measuring points.

The invention relates to a method for measuring a cutting tool comprising a cutting tool body and at least one cutting insert with at least one cutting edge attached to the cutting tool body, and to a device for carrying out the method.

Cutting tools include machining tools for chip removing manufacturing processes and tools for dividing. They usually have a shaft and a cutting part. The shaft is used to hold the cutting tool, for example in a machine interface for machine cutting tools. The shaft is provided with the cutting part. The cutting part includes at least one cutting edge for the cutting tool to interact with the workpiece to be machined, thereby removing material from the workpiece. Examples of such cutting tools are milling cutters, drills, reamers, chisels, scrapers, planers and saws. The cutting tool can be a solid tool made entirely from a single material. Alternatively, the cutting part may have a cutting insert that surrounds the cutting edge, where the cutting insert is made of a different material to the shaft. Cutting tools are subject to considerable mechanical and thermal stresses in the field due to the forces and temperatures they are subjected to. These include mechanical friction, oxidation and abrasion, as well as diffusion and scaling, especially at high cutting speeds. This leads to wear of the cutting tool at the cutting edge.

To improve the wear resistance of cutting tools and increase tool life, cutting tools are provided with a material in the area of the cutting edge that is harder than the rest of the cutting tool body. For a cutting tool with a cutting insert, either the cutting insert can be provided with a hard coating or the entire cutting insert can be made of a hard material. Such hard or ultra-hard materials include diamond, such as polycrystalline diamond PCD, single crystal diamond, crystalline diamond or diamond from chemical vapour deposition CVD, amorphous carbon known as diamond-like carbon DLC, cubic boron nitride CBN, titanium or ceramics. If the cutting insert has a hard material coating, this can be applied to the cutting insert by chemical vapour deposition (CVD), for example.

Cutting inserts are usually soldered directly onto the cutting tool body. Although this connection is very strong, soldering is not precise enough to ensure the exact positioning of the cutting inserts on the cutting tool body. In addition, the cutting inserts may have certain inaccuracies in shape, length, width, depth or curvature of their surfaces. These inaccuracies of the cutting inserts and inaccurate positioning of the cutting inserts on the cutting tool body will result in the associated cutting tool not meeting the specified tolerances and being of poor quality. Target data is specified for the cutting edge. For example, the position of the cutting edge in relation to a cutting tool-based coordinate system, the geometry of the cutting edge or the profile of the cutting edge in relation to the cutting edge-based coordinate system. In order to find out whether the cutting edge of the cutting insert, after the cutting insert has been soldered to the cutting tool body, has these desired cutting edge target data and how much the real cutting edge deviates from the cutting edge target data, it is necessary to record the cutting edge real data. By comparing the cutting edge real data with the cutting edge target data, it is determined how much material needs to be removed at which point on the cutting insert so that after the material is removed, the cutting edge fulfils the specified cutting edge target data within the specified tolerances. The desired material removal is carried out using a machining device. This may be provided with, for example, a grinding wheel, a laser to produce a laser beam, or an electric discharge machine (EDM).

Before the cutting inserts soldered onto the cutting tool body can be reworked with the machining device, the exact position of each cutting insert must be determined in three dimensions in relation to the known references of the cutting tool. It is also necessary to determine whether the surfaces are flat or curved. For example, if the cutting tool is a rotary tool that rotates about a geometric axis of rotation of the cutting tool in use, the geometric cutting tool axis of rotation can, for example, be a reference point. Another reference point can be a top face of the cutting tool or a bottom face of the cutting tool.

From the detected position, alignment and shape of the cutting inserts, and from the comparison of the cutting edge real data with the cutting edge target data, the path along which the material removal device must be moved relative to the cutting tool is determined in order to achieve the necessary material removal required to finish the cutting inserts for the reworking.

It is well known that the position of soldered cutting inserts on a cutting tool can be detected using a mechanical, electrical or optical probe or measuring head. Detection can be tactile, for example with the measuring head touching the surface of the cutting insert, or non-contact. The measuring head is located on the machining device or on a coordinate measuring device. The measuring head is moved relative to the cutting tool to determine the coordinates of measuring points on the surface of the cutting insert. Depending on the type and shape of the cutting tool and the type and number of cutting inserts on the cutting tool, the measuring head must be moved relative to the cutting tool in such a way that it measures the position of the surface relative to a reference point, such as the geometric cutting tool axis of rotation, at a minimum of three measuring points on each cutting insert. A coordinate system is defined for this purpose. The coordinates of the measuring points are determined by the measuring head. The relative movement of the measuring head to the cutting tool is usually controlled by a computer, for example a CNC. The software must be written and specified by the responsible person, based on the type, number and approximate position on the cutting inserts. The responsible person can use technical specifications and drawings of the cutting tool as a basis, but these specifications do not take into account the inaccuracies caused by the soldering of the cutting inserts. The responsible person must therefore enter the details into the control system so that the probe can be moved to the measuring points of the cutting inserts. This is particularly time consuming for cutting tools with a large number of cutting inserts. There is also a risk of making mistakes when entering the details into the control system.

The object of the invention is to provide a method and a coordinate measuring device to facilitate the measurement of cutting inserts after soldering onto a cutting tool, whereby the measurement is carried out automatically and collision of the coordinate measuring device with the cutting tool is avoided.

This object is solved by a method according to claim 1 and by a coordinate measuring device according to claim 15. The coordinate measuring device is provided with
a fixing device which receives and fixes the cutting tool
a measuring head which probes the surface of the cutting tool arranged in the fixing device with or without contact, the measuring head being movable relative to the fixing device, and
a movement device which moves the cutting tool received in the fixing device and the measuring head relative to each other.

The method is characterised by the following steps
a) specifying geometric measuring head data, including the shape and size of the measuring head,
b) the cutting tool is fixed in the fixing device.
c) defining a three-dimensional coordinate system with an origin and coordinate axes,
d) a three-dimensional surface of the cutting tool arranged in the fixing device is specified at least in those portions of the cutting tool which comprise the cutting insert, whereby this surface is defined as a three-dimensional cutting tool surface. The surface may be specified in the three-dimensional coordinate system.
e) determining those subregions of the three-dimensional cutting tool surface that form a surface of the cutting insert and are located adjacent to the cutting edge of the cutting insert, whereby these subregions are defined as cutting edge boundary surfaces.
f) determining measuring points on the cutting edge boundary surfaces.
g) determining a movement path of the movement device for a relative movement of the measuring head and the cutting tool, whereby the movement path is determined from the geometric measuring head data, the cutting edge boundary surfaces and the measuring points in such a way that, during a relative movement of the measuring head and the cutting tool along the movement path, the coordinates of the cutting tool are detected at the measuring points by the coordinate measuring device and a collision between the cutting tool and the measuring head during the relative movement is avoided.
h) The measuring head is moved relative to the cutting tool along the movement path.
i) The coordinates of the measuring points of the cutting edge boundary surfaces are recorded with respect to the coordinate system of the coordinate measuring device.
j) Finally, the cutting edge boundary surfaces are fitted to the measured coordinates of the measuring points so that the measured coordinates lie on the fitted cutting edge boundary surfaces.

The measuring points are defined, for example, by determining one or two coordinates of the measuring points and positioning the measuring head with respect to this defined coordinate or these defined coordinates relative to the cutting edge boundary surface. The measuring head then detects the missing coordinate or coordinates of the cutting edge boundary surface.

The coordinates are referenced to a predetermined coordinate system. Advantageously this is a cutting tool based coordinate system. This includes coordinate axes that extend through the cutting tool and a zero point in or on the cutting tool. As the cutting tool moves, the cutting tool based coordinate system moves with it. Therefore, when the cutting tool moves, the coordinates of the cutting edge position and the coordinates of the cutting edge contour do not change in this cutting tool based coordinate system.

In principle, the cutting insert does not only have surfaces that are part of the cutting tool surface and are located adjacent to the cutting edge of the cutting insert. For example, the cutting insert also includes those surfaces where the cutting insert is soldered to the cutting tool body. It is assumed that those surfaces of the cutting insert that are part of the cutting tool surface and that are adjacent to the cutting edge of the cutting insert are particularly important to the quality of the cutting tool, and therefore inspection and reworking in this area is particularly important. If necessary, measurements can also be made on surfaces of the cutting insert that are not adjacent to the cutting edge. In general, the areas of the cutting insert where the cutting insert is soldered to the tool body are not measured because these areas are not exposed and therefore do not directly affect the properties of the cutting edge, and because machining in these areas could cause the cutting insert to become detached from the cutting tool body. In addition to these mounting areas and the surfaces that define the cutting edge, the cutting insert may have other surfaces that can be measured.

The three-dimensional cutting tool surface is specified in such a way that no data needs to be entered manually into the coordinate measuring machine. For example, the three-dimensional cutting tool surface can be generated and specified using previously known CAD data of the cutting tool. This CAD data can contain the cutting tool surface in two or three dimensions. For example, the surface of the cutting tool body can be specified in three dimensions and the surface of the cutting insert can be specified in two dimensions. The three-dimensional surface of the cutting tool is then determined from this data. In this case, the three-dimensional surface of the cutting tool corresponds to, or is part of, the theoretical geometric surface of the cutting tool generated from the CAD design of the cutting tool. Alternatively, the three-dimensional surface can be generated using a surface scanner based on the cutting tool clamped in the fixing device and entered into the fixing device. In this case, the three-dimensional cutting tool surface is the actual surface of the cutting tool after the cutting inserts have been soldered. In both cases, there is no need to manually enter the surface data into the system. The process is therefore much less laborious and error-prone for the user.

By analyzing the three-dimensional cutting tool surface, the subregions that form a surface of the cutting insert and are located adjacent to a cutting edge are determined. These subregions are characterised by the fact that they have a certain alignment relative to a reference value of the cutting tool, for example the geometric cutting tool axis of rotation, the bottom side or the top side of the cutting tool. This property of the surfaces of the cutting inserts is used in their determination. The method according to the invention determines the cutting edge boundary surfaces regardless of how and in what way the three-dimensional cutting tool surface is specified. No data or information needs to be entered by the user for this purpose.

By analyzing the three-dimensional cutting tool surface and determining the cutting edge boundary surfaces from this, the position, alignment, possible curvature of the surface and the length, width or depth of the cutting inserts can be determined.

The cutting edge boundary surfaces determined from the three-dimensional cutting tool surface are adapted to the coordinates obtained during probing with the measuring head. If the measuring points with the recorded coordinates are already on the cutting edge boundary surfaces, the cutting edge boundary surfaces do not need to be changed. If the measured points with the recorded coordinates do not lie on the cutting edge boundary surfaces, the cutting edge boundary surfaces must be modified so that the measured points lie on the modified cutting edge boundary surfaces. The cutting edge boundary surfaces if necessary with the adjustment using data from the scanning, can be used to determine, for example, how a material removal device must be moved relative to the cutting tool in order to remove material from the cutting inserts in a desired manner, so that the soldered-on cutting inserts are reworked and the cutting tool meets the specifications for the position, alignment and path of the cutting edge and the surfaces bounded by the cutting edge within certain tolerances.

When determining the movement path for the relative movement of the measuring head and cutting tool, the geometry and dimensions of the measuring head and cutting tool are taken into account so that the relative movement is collision-free.

The following surfaces can be associated with the cutting tool
1. a theoretical three-dimensional geometric surface of the cutting tool resulting from its design; if the cutting tool is designed using CAD, the theoretical three-dimensional geometric surface of the cutting tool can be derived from the CAD data. This surface may not include the inaccuracies resulting from the manufacture of the cutting insert and the soldering of the cutting insert.
2. the actual three-dimensional surface of the cutting tool after soldering of the cutting insert; this surface includes the inaccuracies resulting from the manufacture of the cutting insert and the soldering of the cutting insert; this surface can be determined, for example, by a surface scanner that scans the entire surface of the cutting tool. The surface determined by the surface scanner is checked at predetermined measuring points with a measuring head. Alternatively, this surface can be determined using the data from section 1 and then probing the cutting insert surfaces at predetermined measuring points with the measuring head. In both cases, the specified surfaces of the cutting insert are corrected so that the coordinates of the measuring points lie on the cutting insert surfaces. The number of measuring points depends on the accuracy of the given three-dimensional surface. The higher the accuracy of the given surface, the fewer measuring points are required. The three-dimensional cutting tool surface according to claim 1 can be derived from the theoretical three-dimensional surface according to FIG. 1 or from the actual three-dimensional surface according to FIG. 2.
3. Cutting edge boundary surfaces determined from the three-dimensional cutting tool surface:
   The cutting edge boundary surfaces can be determined from the theoretical geometric three-dimensional surface of the cutting tool according to section 1 above or from the actual three-dimensional surface of the cutting tool after soldering on the cutting insert according to section 2 above.
4. measuring points are determined on the cutting edge boundary surfaces. The surface of the cutting tool located in the fixing device is scanned at these measuring points using the measuring head. This serves to adapt the theoretical cutting edge boundary surfaces to reality. The cutting edge boundary surfaces are adapted so that the coordinates of the measuring points, as scanned by the measuring head, lie on the cutting edge boundary surfaces. These cutting edge boundary surfaces represent the cutting edge real data.

In the method according to the invention, the three-dimensional cutting tool surface is specified according to section 1 above or section 2 above and the cutting edge boundary surfaces are determined therefrom according to section 3 above. It is assumed that the adapted cutting edge boundary surfaces according section 4 correspond to the corresponding real surfaces on the cutting tool clamped in the fixing device and to be machined and have the cutting edge real data. Based on these cutting edge boundary surfaces, material removal can be carried out if necessary to adapt the cutting edges to predefined cutting edge target data.

The data required to measure the cutting inserts on the cutting tool is automatically determined from the cutting tool surface, without the responsible Person having to make any manual entries and without the operator having to determine any measurement data. This considerably simplifies measurement. As no input errors can occur, the measurement is also more accurate.

The measurement range and an device coordinate system are defined by the motion axes and their guides, drives and incremental encoders of the movement device. The device coordinate system is not the same as a cutting tool-based coordinate system. However, it is possible to transform the coordinates of the device coordinate system to the cutting tool based coordinate system. A movement device with x, y and z axes will typically result in a Cartesian device coordinate system. However, movement devices whose guides span a cylindrical or spherical coordinate system are also common. They use a combination of incremental displacement and angle sensors.

The measuring head can be fitted with either touch-trigger or measuring sensors. Touch-trigger sensors simply provide a trigger signal when a measuring point is picked up, which initiates the readout of the linear encoders. Measuring sensors, on the other hand, have their own internal measuring range of a few millimetres. The internally measured sensor value is superimposed on the sensor position determined by the linear encoders.

In order to avoid undesired collisions between the material removal device and the cutting tool, the geometric measuring head data, which includes the shape and size of the measuring head, is taken into account when determining the movement path. This can be done using known collision avoidance calculation methods. In this case, the specified data of the cutting tool and the measuring head are taken into account. Known collision avoidance calculation methods can be used. For example, a Minkowski addition can be used. Other calculation methods are also possible.

According to an advantageous embodiment of the invention, the coordinate system is a cutting tool-bound coordinate system.

According to a further advantageous embodiment of the invention, the cutting tool is a rotary cutting tool which is rotated about a geometric cutting tool axis of rotation during its use. The geometric cutting tool axis of rotation corresponds to the axis about which the cutting tool is rotated at its subsequent point of use. Advantageously, the cutting tool, which is designed as a rotary tool, is received in the fixing device in such a way that it is rotated about the geometric cutting tool axis of rotation by means of the movement device. One of the coordinate axes of the coordinate system coincides with the cutting tool rotation axis.

According to a further advantageous embodiment of the invention, the alignment of the cutting edge boundary surfaces relative to the geometric cutting tool axis of rotation is determined. This takes advantage of the fact that cutting inserts usually have a certain alignment relative to the geometric cutting tool axis of rotation. This alignment is a prerequisite for the cutting inserts to achieve the desired material removal at the subsequent point of application of the cutting tool.

According to a further advantageous embodiment of the invention, the position of the cutting edge boundary surfaces relative to the geometric cutting tool axis of rotation is determined. This takes advantage of the fact that the cutting inserts usually have a certain position relative to the geometric cutting tool axis of rotation.

According to a further advantageous embodiment of the invention, the position of the cutting edge boundary surface relative to an end face of the cutting tool is determined. When the cutting tool is configured as a rotary tool that is rotated about a cutting tool axis of rotation at the point of use and that extends along the cutting tool axis of rotation from a first end to a second end, the end face is preferably a surface of the cutting tool that is perpendicular to the cutting tool axis of rotation at the first end or at the second end.

According to a further advantageous embodiment of the invention, the coordinates determined at the measuring points are used to check whether the cutting edge boundary surfaces are curved or flat. For example, if it is determined that one of the cutting edge boundary surfaces has a curvature that results in an undesirable curvature of the cutting edge, the corresponding cutting edge boundary surface can be smoothed by reworking and converted to a flat surface so that the cutting edge has a predetermined straight course. If the cutting edge boundary surfaces have a curvature as specified, it is advantageous to specify more than three measuring points.

According to a further advantageous embodiment of the invention, the cutting insert consists of an ultra-hard material such as polycrystalline diamond (PCD), cubic boron nitride (CBN), diamond from chemical vapour deposition (CVD), single crystal diamond or ceramic. In the case of a coating, this can be applied by CVD. Alternatively, diamond-like amorphous carbon DLC may be used.

According to a further advantageous embodiment of the invention, the three-dimensional cutting tool surface is determined from the given CAD data of the cutting tool. A geometric model of the cutting tool is available as a digital data set as a result of the computer aided design and manufacture of the cutting tool with at least one cutting insert. The CAD data contains this digital record. The theoretical geometric three-dimensional cutting tool surface can be calculated from the CAD data. As the CAD data is derived from the geometric model, it does not contain the inaccuracies caused by the manufacturing of the cutting inserts and the soldering of the cutting inserts to the cutting tool body. It is therefore not an exact representation of reality. For this reason, it may be advantageous to define measuring points on the surface of the cutting inserts, to capture the real cutting edge boundary surfaces by scanning at the measuring points with a measuring head, and to adapt the cutting edge boundary surfaces to the scan data.

According to a further advantageous embodiment of the invention, the three-dimensional cutting tool surface is generated by a surface scanner. The surface scanner is provided with one or more sensors which scan or measure the cutting tool in a systematic and regular manner. A large number of individual measurements are used to create an overall image of the cutting tool. The measurements taken by the sensors are converted into digital data and processed by a computer. The three-dimensional cutting tool surface can be calculated from this data. It may be that the three-dimensional surface of the cutting tool captured by the surface scanner is a very good representation of the real surface of the cutting tool. In this case, measuring points are defined on the cutting insert surface and the surface is measured at these measuring points with a measuring head to check the quality of the surface captured by the scanner. Probing is used as a check. If, for example, during such a check on one surface of the cutting insert, it is found that the coordinates recorded by the measuring head are part of the three-dimensional cutting tool surface recorded by the surface scanner, then no further checks on the remaining surfaces of the cutting insert may be necessary. If, on the other hand, deviations are found, the inspection can continue.

According to a further advantageous embodiment of the invention, a grid of partial surfaces is laid over the three-dimensional cutting tool surface. The alignment relative to a reference point, for example the geometric cutting tool axis of rotation is determined for each partial surface. From this, the cutting edge boundary surfaces are determined.

According to a further advantageous embodiment of the invention, the partial surfaces are triangles. Alternatively, the partial surfaces may also be rectangles or other polygons.

According to a further advantageous embodiment of the invention, the alignment of each two adjacent partial surfaces is compared with each other. From this, the cutting edge boundary surfaces are determined. Use is made of the fact that adjacent partial surfaces which have the same or a similar alignment belong to the same cutting edge boundary surface.

According to a further advantageous embodiment of the invention, the coordinates of the measuring points of the cutting edge boundary surfaces are detected by contact with a tactile sensor of the measuring head. Such sensors are also referred to as mechanical sensors.

According to a further advantageous embodiment of the invention, the coordinates of the measuring points of the cutting edge boundary surfaces are detected without contact using an optical or electrical sensor of the measuring head.

According to a further advantageous embodiment of the invention, the collision-free movement path is determined by a Minkowski addition. Alternatively, other calculation methods can be used to determine a collision-free movement path.

The coordinate measuring device according to the invention is characterised in that it is provided with a control device which controls the fixing device, the measuring head and the movement device in such a way that they carry out the method according to the invention.

Further advantages and advantageous embodiments of the invention will be apparent from the following description, the drawing and the claims.

### DRAWING

The drawing shows embodiments of the subject matter of the invention. It shows

FIG. 1: Perspective view of a first embodiment of a cutting tool measured by the method according to the invention, representation based on CAD data,

FIG. 2: Perspective view of the cutting tool according to FIG. 1 based on data obtained using a surface scanner, represented by triangles,

FIG. 3: Representation according to FIG. 2 using different shades of grey,

FIG. 4: Perspective view of the cutting tool according to FIGS. 1, 2 and 3 after reworking,

FIG. 5: Representation of the cutting tool according to FIG. 1, with the outer cutting tool geometry marked,

FIG. 6: Representation of the cutting tool according to FIG. 1 with the movement path of a measuring head,

FIG. 7: Representation of the cutting tool according to FIG. 1 with marking of the measuring points at which the surface of a cutting insert is probed with the measuring head,

FIG. 8: Comparison of the CAD data and the data determined with the surface scanner for the cutting tool according to FIGS. 1 to 7,

FIG. 9: Perspective view of a second example of a cutting tool measured using the method according to the invention, representation based on CAD data,

FIG. 10: Perspective view of the cutting tool of FIG. 9 based on data obtained using a surface scanner,

FIG. 11: Detail of FIG. 9,

FIG. 12: Detail of FIG. 11,

FIG. 13: Part of the cutting tool according to FIGS. 9 and 10 after reworking,

FIG. 14: Coordinate measuring device for carrying out the method.

### DESCRIPTION OF THE EMBODIMENTS

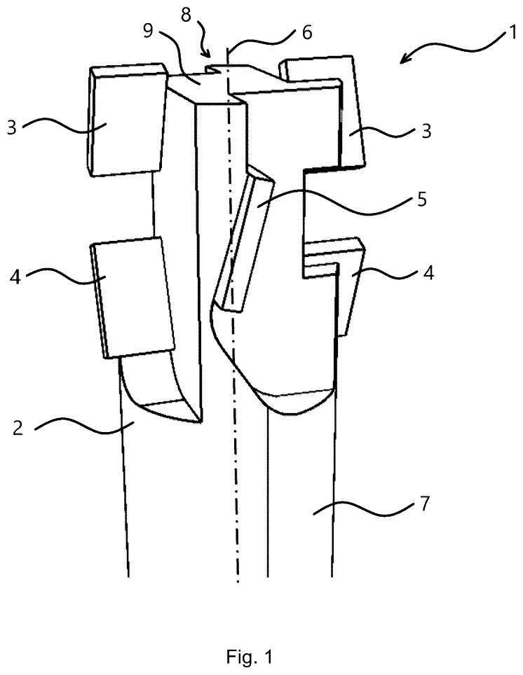

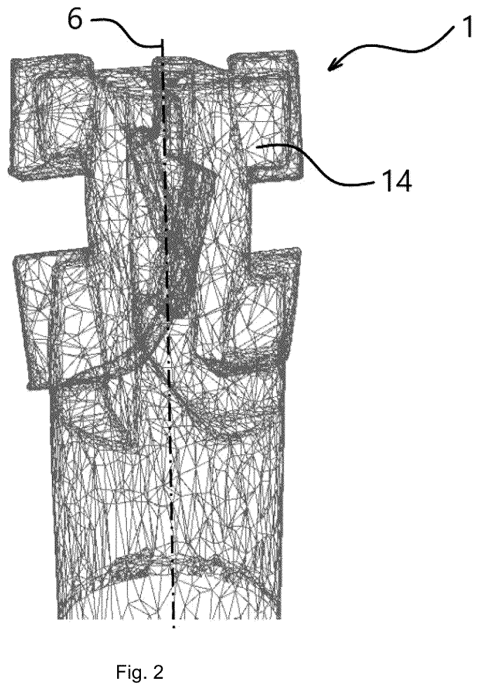

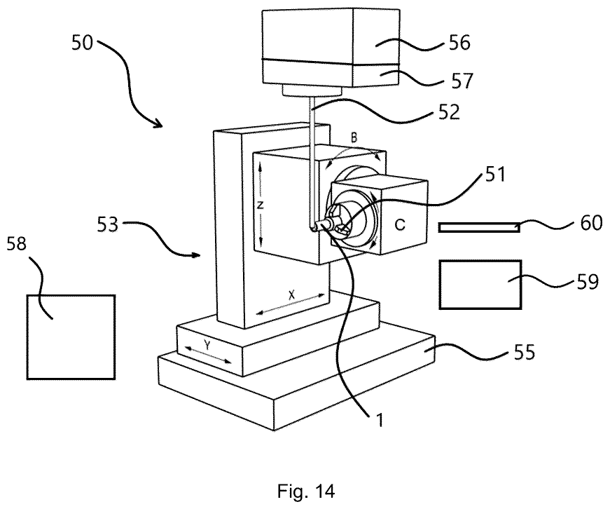

FIGS. 1 to 8 show a first cutting tool that is measured using the method according to the invention. The coordinate measuring device used for the measurement is shown in FIG. 14. FIGS. 1 and 2 show the cutting tool prior to measurement. FIG. 1 corresponds to a representation of the CAD data of the cutting tool as specified by the CAD design of the cutting tool. FIG. 2 corresponds to a representation of the data obtained using a surface scanner. The cutting tool 1 comprises a cutting tool body 2 on which a total of six cutting inserts 3, 4, 5 are arranged. The cutting tool is a rotary tool that is rotated at its point of use about a geometric cutting tool axis of rotation 6. The cutting tool is not shown in its entirety in the drawing. A shaft 7, which is used to hold the cutting tool 1 in a machine not shown, is only partially shown for reasons of clarity. There are no cutting inserts in the unshown part of the cutting tool. Therefore, the method does not measure in the non-represented part of the cutting tool. The portion of the cutting tool 1 in which the cutting inserts 3, 4, 5 are arranged on the cutting tool body 2 is defined as the three-dimensional cutting tool surface. This three-dimensional cutting tool surface is visible at least in FIGS. 1 and 2 as far as it faces the viewer. The parts of the three-dimensional cutting tool surface facing away from the viewer are covered by the cutting tool body 2 in FIGS. 1 and 2.

The cutting inserts 3, 4, 5 are arranged offset in relation to the cutting tool axis of rotation. The first two cutting inserts 3 are located at one end 8 of the cutting tool. They are arranged offset by 180° relative to each other on the cutting tool body 2 and inclined by an angle a relative to the cutting tool axis of rotation. The two second cutting inserts 4 are arranged in the axial direction with respect to the cutting tool axis of rotation 6 at a distance from the end 8 and from the two first cutting inserts 3. They are mounted on the cutting tool body in the axial direction offset from the first cutting inserts 3. The angular distance between the two second cutting inserts is also 180°. The two third cutting inserts 5 are located between the two first and second cutting inserts 3, 4 in terms of their axial position and their angular position. In the drawing, only one of the two third cutting inserts 5 is visible, as the other third cutting insert 5 is hidden by the cutting tool body 2.

The first, second and third cutting inserts 3, 4, 5 are soldered to the cutting tool body 2. After soldering, the cutting inserts 3, 4, 5 initially protrude radially outwards beyond the cutting tool body 2. FIGS. 1 and 2 show the cutting tool after soldering of the cutting inserts 3, 4, 5. In particular, the portion of the first cutting inserts 3 and the second cutting inserts 4 projecting radially beyond the cutting tool body is clearly visible.

FIG. 1 shows a representation of the cutting tool 1 based on CAD data. This CAD data is the result of the computer aided design of the cutting tool. It shows the three-dimensional cutting tool surface which includes the cutting inserts 3, 4, 5.

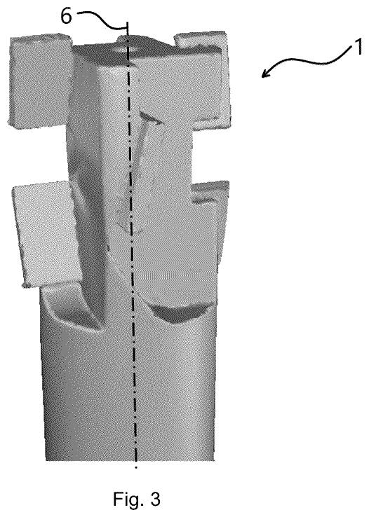

FIG. 2 shows a representation of cutting tool 1 based on data obtained using a surface scanner. This surface scanner is shown in FIG. 14 with reference number 59. The surface scanner is used to scan the surface of the cutting tool 1 from all sides in the areas where the cutting inserts 3, 4, 5 are located. The result is the three-dimensional surface of the cutting tool, which is essential for the process. As shown in FIG. 2, the surface of the cutting tool 1 has been scanned in exactly the same section of the cutting tool 1 as shown in FIG. 1 based on the CAD data. The surface scanner provides a set of surface points. These are connected by lines in FIG. 2 to form triangles. FIG. 3 shows an alternative representation based on the same set of surface points as FIG. 2, but instead of triangles, different shades of grey are shown. The shape of the cutting tool 1 is easier to see in this representation than in FIG. 2.

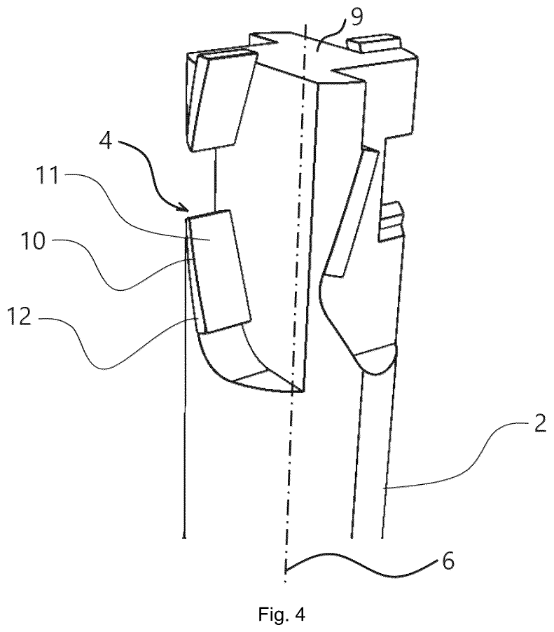

FIG. 4 shows the cutting tool 1 with the cutting inserts 3, 4, 5, whereby the cutting inserts fulfil predetermined criteria with respect to the position and course of their cutting edges 10. In particular, these are predetermined cutting edge target data, such as the position and course of the cutting edge in relation to the cutting tool axis of rotation. The cutting inserts 3, 4, 5 protrude significantly less radially outwards from the cutting tool body 2. As shown by the second cutting insert 4, the cutting edge 10 delimits a first cutting edge boundary surface 11 and a second cutting edge boundary surface 12. The same applies to the first cutting inserts 3 and the third cutting inserts 5.

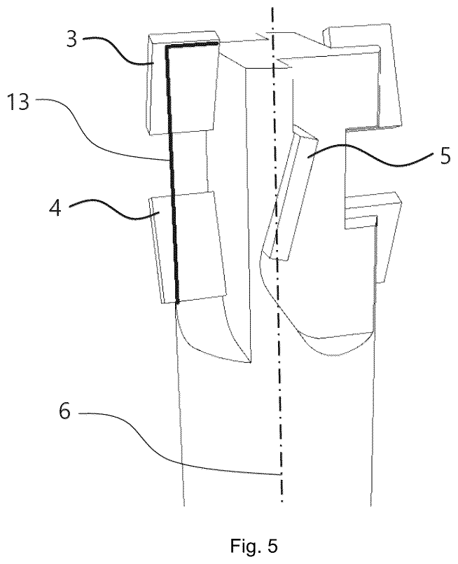

FIG. 5 shows the cutting tool 1 according to FIGS. 1 and 2 with the outer geometry 13 of the cutting tool, which is defined by the predetermined course of the cutting edges 10 of the cutting inserts 3, 4, 5, which is marked by a line in the area of the first cutting insert 3 and the second cutting insert. The figure thus visualizes the cutting edge real data and the cutting edge target data. By comparing these data, it can be seen from the representation that the area of the cutting inserts 3, 4, 5 which protrudes beyond the outer geometry 13 of the cutting tool 1 must be removed. In particular, a first cutting edge boundary surface 11a and/or a second cutting edge boundary surface 12a must be reworked so that these correspond within tolerances with the first cutting edge boundary surface 11 and the second cutting edge boundary surface 12 according to FIG. 4 and the cutting edge 10 thus has the predetermined shape.

In order to enable the cutting inserts 3, 4, 5 to be machined in the region of the cutting edge boundary surfaces 11a, 12a, the three-dimensional surface of the cutting tool 1 is determined on the basis of the CAD data according to FIG. 1 or on the basis of the data determined by the surface scanner according to FIG. 2. The totality of these given data is referred to as the three-dimensional cutting tool surface. From this three-dimensional cutting tool surface, those subregions are determined which form a surface of a cutting insert 3, 4, 5 and are arranged adjacent to a cutting edge. These are referred to as cutting edge boundary surfaces 11a, 12a. They are determined by comparing the alignment or position of the surfaces with the cutting tool axis of rotation 6 or an end face 9 of the cutting tool. For this purpose, the three-dimensional cutting tool surface is divided into a grid of partial surfaces 14. In the representation according to FIG. 2, the grid with the partial surfaces 14 corresponds to the triangles resulting from the connection of the surface points. For each partial surface 14, the alignment relative to the geometric axis cutting tool axis of rotation 6 is determined. Alternatively or cumulatively, the alignment relative to the end face 9 of the cutting tool can also be determined for each partial surface 14. Adjacent partial surfaces 14 having the same alignment are assigned to a common surface. The cutting edge boundary surfaces 11a, 12a differ from other surfaces of the cutting tool 1 in that they have a very specific predetermined alignment relative to the cutting tool axis of rotation 6 or to the end face 9.

The cutting edge real data is determined from the cutting edge boundary surfaces. It relates to at least one property of the cutting edge, namely the cutting edge position relative to a cutting tool based coordinate system, the cutting edge geometry or the cutting edge contour relative to the cutting edge based coordinate system.

Cutting edge target data are specified for the cutting tool, which relate to the corresponding property from the set of properties mentioned above: cutting edge position relative to a cutting tool based coordinate system, cutting edge geometry, cutting edge contour relative to the cutting edge based coordinate system. The cutting tool shown in FIG. 4 has these cutting edge target data.

The cutting edge real data is compared with the cutting edge target data. This comparison indicates whether and how much material must be removed from the defined cutting edge boundary surfaces 11a, 12a so that the cutting edge 10 has the cutting edge target data and the specified profile with the specified outer geometry 13.

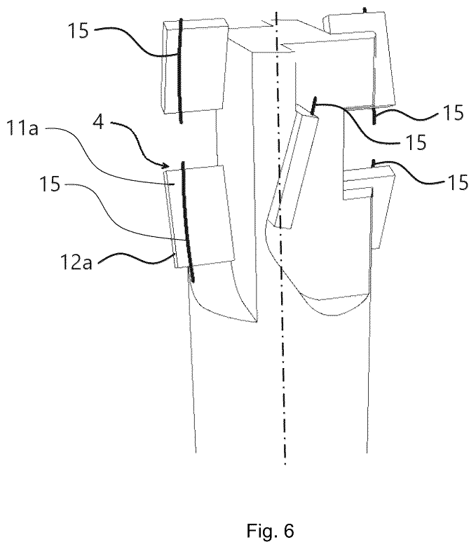

A movement path 15 is determined from the geometrical measuring head data, the cutting edge boundary surfaces 11a, 12a, 31a, 32a and the measuring points 16 shown in FIG. 7, along which the measuring head is moved relative to the cutting tool by means of the movement device in order to determine the coordinates of the cutting edge boundary surfaces. In FIG. 6, this movement path 15 is shown at the first, second and third cutting inserts 3, 4, 5. The movement path 15 extends beyond the cutting edge boundary surfaces 11a, 12a to ensure that the entire cutting edge surface 11a, 12a is probed if necessary. The movement path is specified in such a way that the coordinates of all the specified measuring points are recorded without the measuring head colliding with the cutting tool.

If the three-dimensional cutting tool surface resulting from the CAD data according to FIG. 1 does not sufficiently represent reality, or if a check of the three-dimensional cutting tool surface according to FIG. 1, 2 or 3 is desired, measuring points are determined on at least one cutting edge boundary surface 11a, at which the coordinates of the cutting edge boundary surface are determined by a coordinate measuring device. In the present case, three measuring points 16 are determined on the first cutting edge boundary surface 11a. The coordinates of the cutting edge boundary surface are then determined at these three measuring points 16 using the coordinate measuring device. The measured data obtained at these measuring points 16 are compared with the cutting edge boundary surface 11a. In the event of a deviation, the cutting edge boundary surface 11a is corrected and adjusted accordingly so that the coordinates of the measuring points lie on the cutting edge boundary surface 11a. Such a check of the cutting edge boundary surfaces 11a, 12a can also be carried out if the three-dimensional cutting tool surface is determined by a surface scanner according to FIG. 2 or 3. Since the surface scanner already detects the surface of the real cutting tool, it is assumed that in this case a check is necessary for control purposes.

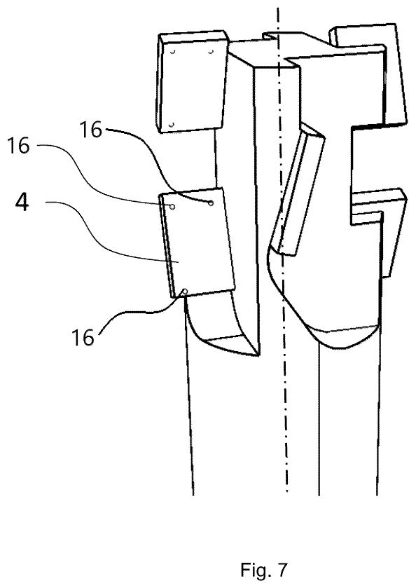

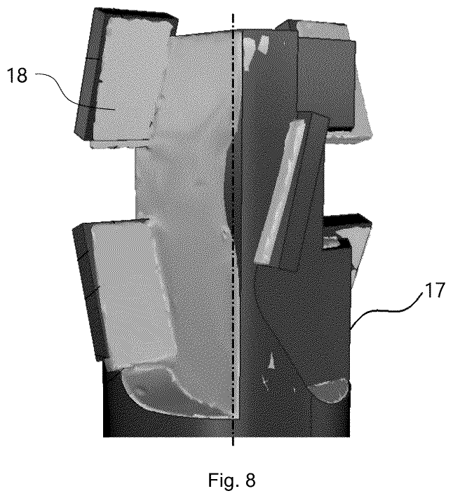

FIG. 8 shows a comparison of the three-dimensional cutting tool surface 17 determined using CAD data with the three-dimensional cutting tool surface 18 determined using a surface scanner. In the light grey areas, the three-dimensional cutting tool surface 18 determined by the surface scanner protrudes above the three-dimensional cutting tool surface 17 determined by the CAD data. In the dark grey areas, the opposite is true.

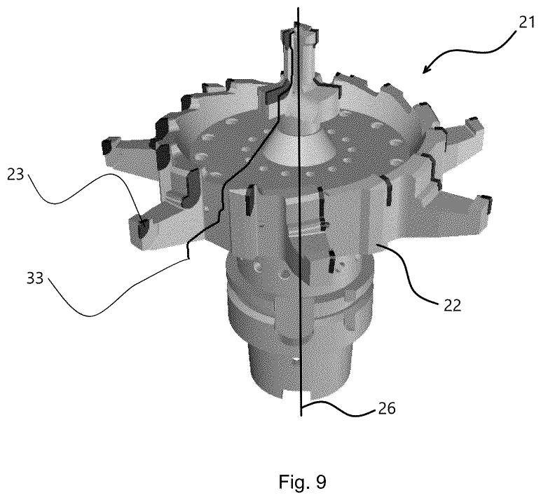

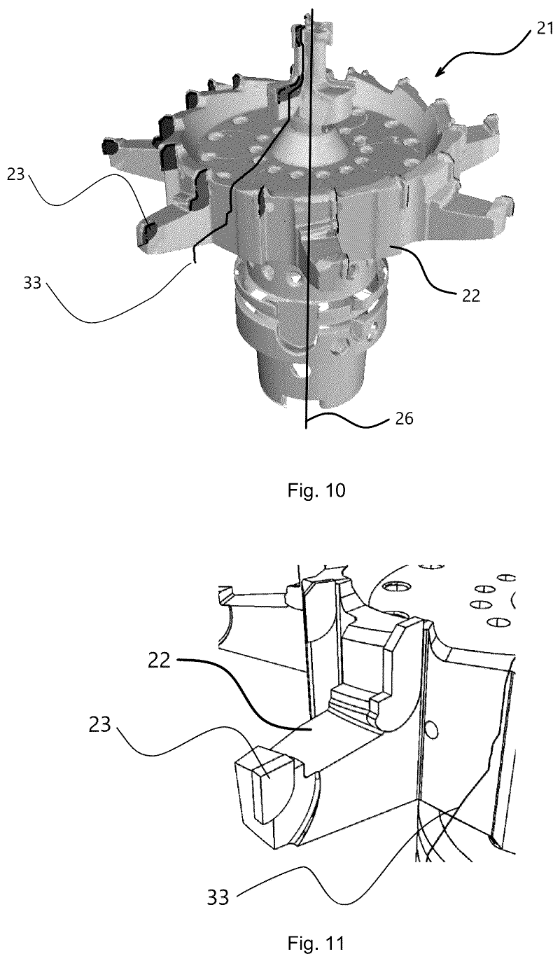

FIGS. 9 to 13 show a second example of a cutting tool 21 measured using the method according to the invention. FIGS. 9 and 10 show the cutting tool 21. FIG. 9 corresponds to a representation of CAD data of the cutting tool 21 specified by the design of the cutting tool using CAD. FIG. 10 corresponds to a representation of data determined using a surface scanner. The cutting tool 21 comprises a cutting tool body 22 on which a plurality of cutting inserts 23 are arranged. The cutting tool is a rotary tool which is rotated at its point of use about a geometric cutting tool rotation axis 26. In contrast to the first embodiment of a cutting tool according to FIGS. 1 to 8, in the cutting tool 21 according to the second embodiment all cutting inserts 23 are arranged on the cutting tool body 22 in the same axial position relative to the cutting tool axis of rotation 26 and with the same alignment relative to the cutting tool axis of rotation 26.

For each cutting insert 23 arranged on the cutting tool body 22, criteria for the course and position of a cutting edge 30 of the cutting insert 23 with respect to the cutting tool axis of rotation 26 of the cutting tool are specified as cutting edge target data. This specified cutting edge 30 is shown in FIG. 13. The specified cutting edge 30 defines a first cutting edge boundary surface 31 and a second cutting edge boundary surface 32. An outer geometry 33 of the cutting tool 21 is specified by the course and position of the cutting edges 30 of all cutting inserts 23 of the cutting tool 21. This outer geometry 33 is marked by a line in FIGS. 9 and 10.

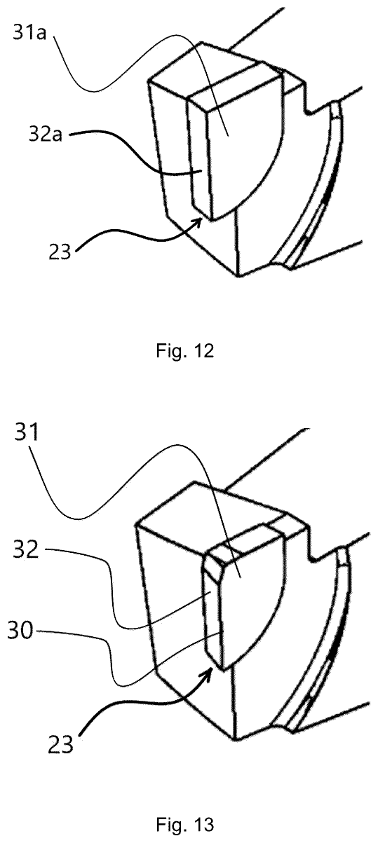

To carry out the method, the cutting edge boundary surfaces 31a, 32a of the cutting inserts 23 are determined from the three-dimensional cutting tool surface of the CAD data according to FIG. 9 or the data determined with a surface scanner according to FIG. 10, and real cutting edge data are derived therefrom. These are compared with specified cutting edge target data. FIGS. 11 and 12 show the two cutting edge boundary surfaces 31a and 32a as exemplified by a cutting insert 23. From the comparison with the specifications for the cutting edge 30, the first cutting edge boundary surface 31 and the second cutting edge boundary surface 32, it can be seen that material removal must take place and to what extent. On the basis of the data thus determined, a machining device can be controlled so that the appropriate material is removed and the cutting edge 30 meets the specifications shown in FIG. 13.

The determination of the position and alignment of the cutting edge boundary surfaces 31a, 32a from the three-dimensional cutting tool surface is carried out in a manner corresponding to the first embodiment, as shown in FIGS. 1 to 8.

FIG. 14 shows a coordinate measuring device 50 for carrying out the method. The coordinate measuring device is combined with a laser 56 for material removal. The coordinate measuring device comprises a fixing device 51 which receives and fixes a cutting tool 1, a movement device 53 which moves the cutting tool 1 arranged in the fixing device relative to a device base 55, a laser 56 which generates a laser beam 52, and a laser beam deflection device 57 which guides the laser beam 52. In the present case, the movement device 53 has three linear axes X, Y, Z and two rotational axes B and C. The rotational axis C causes the cutting tool 1, which is arranged in the workpiece fixing device 51, to rotate about a geometric cutting tool rotary axis which passes through the cutting tool.

The coordinate measuring device 50 is also provided with a surface scanner 59 which detects the surface of the cutting tool 1 located in the fixing device 51 and stores the determined three-dimensional cutting tool surface. This three-dimensional cutting tool surface is output to the control device 58, which uses it to determine the cutting edge boundary surfaces of the cutting inserts.

The coordinate measuring device 50 is provided with a measuring head 60 for determining the surface of the cutting tool 1 arranged in the fixing device at the specified measuring points and for assigning the coordinates to a coordinate system. It is then checked whether these determined coordinates lie on the specified cutting edge boundary surface. If this is not the case, the cutting edge boundary surface is corrected so that the coordinates of the measuring points lie on the adapted cutting edge boundary surface. The measuring head 60 is controlled and moved in such a way that a collision between the cutting tool and the measuring head is avoided. A relative movement between the cutting tool 1 and the measuring head is carried out with the movement device 53.

If the measurement of the cutting tool shows that material needs to be removed from the cutting insert, this material removal can be carried out with the laser. The laser beam deflection device 57 moves and guides the laser beam 52 in three different directions in space. In this case, the laser beam 52 is moved along a laser path (not shown) relative to the cutting tool 1. The control device 58 controls the fixing device 51, the movement device 53 and the laser beam deflection device 57 in order to remove material from the cutting tool in a targeted manner.

The control device 58 thus controls not only the movement device 53 and the measuring head 60, but also the laser 56. The material to be removed is determined from the cutting edge real data and the target cutting edge data. The laser and the movement device are controlled in such a way that this material is removed from the cutting inserts of the cutting tool 1.

Any of the features of the invention, individually or in any combination, may be essential to the invention.

### REFERENCE NUMBERS

1 Cutting tool
2 Cutting tool body
3 First cutting insert
4 Second cutting insert
5 Third cutting insert
6 Cutting tool axis of rotation
7 Shaft
8 End
9 End face
10 Cutting edge
11 First surface defining the cutting edge after machining
11a First surface defining the cutting edge before machining
12 Second cutting edge defining surface after machining
12a Second surface defining the cutting edge before machining
13 Outer geometry of cutting tool
14 Partial surface
15 Movement path of the measuring head
16 Measuring point
17 Three-dimensional tool surface determined from CAD data
18 Three-dimensional tool surface determined by surface scanner
21 Cutting tool
22 Cutting tool body
23 Cutting insert
26 Cutting tool axis of rotation
30 Cutting edge
31 First cutting edge surface after machining
31a First boundary surface before machining
32 Second boundary surface after machining
32a Second boundary surface before machining
33 Cutting tool outer geometry
50 Coordinate measuring device
51 Fixing device
52 Laser beam
53 Movement device
55 Device base
56 Laser
57 Laser beam deflection device
58 Control unit
59 Surface scanner
60 Measuring head

1: A method for measuring a cutting tool (1, 21) which comprises a cutting tool body (2, 22) and at least one cutting insert (3, 4, 5, 23) with at least one cutting edge (10,30) attached to the cutting tool body (2, 22), whereby the measurement is carried out by a coordinate measuring device (50) which comprises
a fixing device (51) which receives and fixes the cutting tool (1, 21),
a measuring head which probes the surface of the cutting tool (1, 21) arranged in the fixing device (51) with contact or without contact, whereby the measuring head is movable relative to the fixing device (51),
a movement device (53) which moves the cutting tool (1, 21) received in the fixing device (51) and the measuring head relative to each other, comprising the following method steps
a) specifying geometric measuring head data, including the shape and size of the measuring head,
b) fixing the cutting tool (1, 21) in the fixing device (51),
c) defining a three-dimensional coordinate system with a zero point and coordinate axes,
d) specifying a three-dimensional surface of the cutting tool (1, 21) arranged in the fixing device (51) at least in those portions of the cutting tool (1, 21) which comprise the cutting insert (3, 4, 5, 23), whereby this surface is defined as a three-dimensional cutting tool surface (17, 18),
e) determining those subregions of the three-dimensional cutting tool surface (17, 18) that form a surface of the cutting insert (3, 4, 5, 23) and are located adjacent to the cutting edge (10, 30) of the cutting insert (3, 4, 5, 23), whereby these subregions are defined as cutting edge boundary surfaces (11a, 12a, 31a, 32a),
f) determining measuring points (16) on the cutting edge boundary surfaces (11 a, 12 a, 31 a, 32a),
g) determining a movement path of the movement device for a relative movement of the measuring head and the cutting tool (1, 21), whereby the movement path is determined from the geometric measuring head data, the cutting edge boundary surfaces (11a, 12a, 31a, 32a) and the measuring points (16), such that during a relative movement of the measuring head and the cutting tool (1, 21) along the movement path, the coordinates of the cutting tool (1, 21) are detected at the measuring points (16) with the coordinate measuring device and a collision between the cutting tool (1, 21) and the measuring head during the relative movement is prevented,
h) moving the measuring head relative to the cutting tool (1, 21) along the movement path and
i) detecting the coordinates of the measuring points (16) of the cutting edge boundary surfaces (11a, 12a, 31a, 32a) in relation to the coordinate system with the coordinate measuring device,
j) adaptation of the cutting edge boundary surfaces (11a, 12a, 31a, 32a) to the detected coordinates of the measuring points (16) in such a way that the detected coordinates lie on the adapted cutting edge boundary surfaces.

2: The method according to claim 1, wherein the coordinate system is a coordinate system linked to the cutting tool.

3: The method according to claim 1-or 2, wherein the cutting tool (1, 21) is a rotary cutting tool which is rotated about a geometric cutting tool axis of rotation (6, 26) during its use and that wherein one of the coordinate axes of the coordinate system coincides with the cutting tool rotation axis.

4: The method according to claim 3, wherein the alignment of the cutting edge boundary surfaces (11a, 12a, 31a, 32a) relative to the geometric cutting tool axis of rotation (6, 26) is determined.

5: The method according to claim 3-or 4, wherein the position of the cutting edge boundary surfaces (11a, 12a, 31a, 32a) relative to the geometric cutting tool axis of rotation (6, 26) is determined.

6: The method according to one of the claim 1, wherein the detected coordinates of the measuring points are used to check whether the cutting edge boundary surfaces (11a, 12a, 31a, 32a) are curved or flat.

7: The method according to claim 1, wherein the three-dimensional cutting tool surface (17) is determined from predetermined CAD data of the cutting tool (1, 21).

8: The method according to claim 1, wherein the three-dimensional cutting tool surface (18) is generated by a surface scanner (59) which scans the surface of the cutting tool.

9: The method according to claim 1, wherein a grid of partial surfaces (14) is laid over the three-dimensional cutting tool surface (17, 18), wherein the alignment relative to the geometric cutting tool axis of rotation (6, 26) is determined for each partial surface (14), and in wherein the cutting edge boundary surfaces (11a, 12a, 31a, 32a) are determined.

10: Method The method according to claim 9, wherein the partial surfaces (14) are triangles.

11: The method according to claim 9-or 10, wherein the alignment of each of two adjacent partial surfaces (14) is compared with each other, and wherein the cutting edge boundary surfaces (11a, 12a, 31a, 32a) are determined.

12: The method according to claim 1, wherein the coordinates of the measuring points (16) of the cutting edge boundary surfaces (11a, 12a, 31a, 32a) are detected by contact with a tactile sensor of the measuring head.

13: The method according to claim 1, wherein the coordinates of the measuring points (16) of the cutting edge boundary surfaces (11a, 12a, 31a, 32a) are detected without contact by an optical or electrical sensor of the measuring head.

14: The method according to claim 1, wherein the collision-free movement path is determined by means of a Minkowski addition.

15: A coordinate measuring device for measuring a cutting tool (1, 21), which comprises a cutting tool body (2, 22) and at least one cutting insert (3, 4, 5, 23) with at least one cutting edge (10, 30) attached to the cutting tool body (2, 22), wherein the coordinate measuring device (50) has
a fixing device (51) receiving and fixing the cutting tool (1, 21),
a measuring head which probes the surface of the cutting tool (1, 21) arranged in the fixing device (51) with contact or without contact, wherein the measuring head is movable relative to the fixing device,
a movement device (53) which moves the cutting tool (1, 21) received in the fixing device (51) and the measuring head relative to each other, wherein the coordinate measuring device (50) comprises a control device (58) which controls the fixing device (51), the measuring head and the movement device (53) in such a way that they carry out the method according to claim 1 on the cutting tool (1, 21).

16: The coordinate measuring device according to claim 14, further comprising a surface scanner (59) which detects the surface of the cutting tool (1, 21) at least in those parts of the cutting tool (1, 21) which comprise the cutting insert (3, 4, 5, 23).

17: The coordinate measuring device according to claim 15, wherein the measuring head comprises at least one tactile sensor which touches the surface of the cutting insert (3, 4, 5, 23) at the measuring points (16).

18: The coordinate measuring device according to claim 15, wherein the measuring head comprises at least one sensor which touches the surface of the cutting insert (3, 4, 5, 23) at the measuring points without contact.

19: The coordinate measuring device according to claim 18, wherein the sensor is an electrical or optical sensor.

20: The coordinate measuring device according to claim 15, wherein the control device is a CNC control.
